(19) United States
(12) Patent Application Publication
(10) Pub. No.: US 2006/0146361 A1
(43) Pub. Date: Jul. 6, 2006

(54) Network scanning from a scanning device

(75) Inventors: Stephen P. Adams, Lexington, KY (US); Larry J. Dicken, Lexington, KY (US); Joshua E. Ellingsworth, Lexington, KY (US); Ronald E. Garnett, Lexington, KY (US); Timothy A. May, Lexington, KY (US); John W. Mehl, Lexington, KY (US); Michael L. Whitlock, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/026,366

(22) Filed: Dec. 30, 2004

(51) Int. Cl. G06F 3/12

(52) U.S. Cl. 358/1.15

(57) ABSTRACT

A method of operating an image scanning system including an image scanner, a network adapter and a memory associated with the image scanner and/or the network adapter. The method including the steps of storing a list of one or more computers that are registered to interact with the image scanner in the memory and selecting one computer from the list of computers as a destination for scanned data and locking out all other computers from interacting with the image scanner until the scanned data is communicated to the selected one computer.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to an image scanning device connected to a network, and, more particularly, to an all-in-one device connected to a network.

2. Description of the Related Art

Multi-function printers (MFPs), also known as all-in-one (AIO) devices provide scanning, printing and copying functions when attached directly to a personal computer. AIOs can also perform standalone functions, such as copying and facsimile transmission. AIOs are typically designed to connect directly to a PC by way of a universal serial bus (USB) connection. A scanning operation is initiated by input from the personal computer directing the scanner to initiate a scan of a document placed therein. Further, the directly connected scanner can initiate a scan from the scanner, since it is directly connected to the personal computer to which the data is directed once the scan is undertaken.

The current art also reflects the ability of a computer on a network to connect to a particular scanning device, thereby locking out all other computers until a scan is completed as initiated by the host computer. A problem with this procedure is the need to initiate the scan from the host computer and/or the need to interact with the scanner, by way of the host computer, to the point of locking other computers from using the scanner until the scan operation is completed.

What is needed in the art is a way of controlling the delivery of scan data by way of the scanning device.

### SUMMARY OF THE INVENTION

The present invention provides the ability to scan from a networked image scanner and to direct the scanned data to an application on a selected computer.

The invention comprises, in one form thereof, a method of operating an image scanning system including an image scanner, a network adapter and a memory associated with the image scanner and/or the network adapter. The method including the steps of storing a list of computers that are registered to interact with the image scanner in the memory and selecting one computer from the list of computers as a destination for scanned data and locking out all other computers from interacting with the image scanner until the scanned data is communicated to the selected one computer.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic illustration of an embodiment of a scanner system of the present invention;

FIG. 2 is a schematic illustration of a method of setting up the scanning system of FIG. 1;

FIG. 3 is a schematic illustration of a method in which a computer is registered in a network adapter of the scanner system of FIG. 1; and

FIG. 4 is a schematic illustration of a method of scanning an image from a scanner in the scanner system of FIG. 1.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

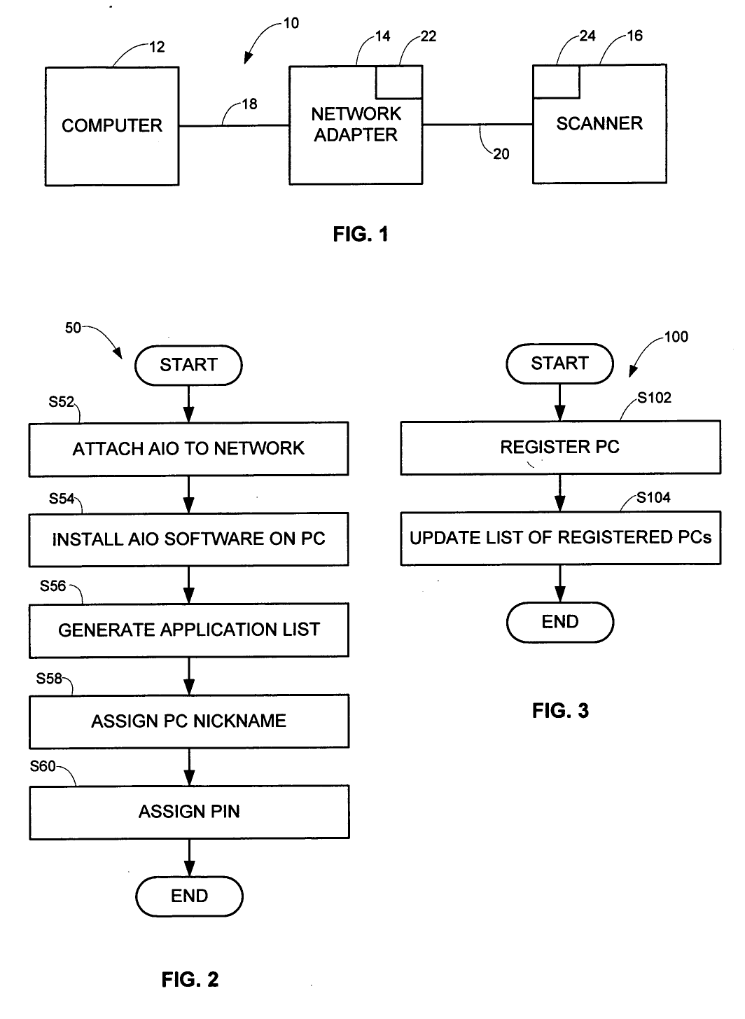

Referring now to the drawings, and particularly to FIG. 1, there is shown a scanning system 10 including a computer 12, a network adapter 14 and an image scanner 16. Computer 12 and network adapter 14 are communicatively linked by way of a communication link 18. In a similar fashion, network adapter 14 is communicatively linked with image scanner 16 by way of communication link 20. Network adapter 14 and scanner 16 respectively have memories 22 and 24 in which information relative to the present invention may be stored. Although memories 22 and 24 are illustrated respective to network adapter 14 and scanner 16, at least one of them may not exist or may exist in a virtual form at another location. Network adapter 14 is illustrated as being external to scanner 16 and may be known as an external network adapter 14. Network adapter 14 has been illustrated as external to scanner 16 for the sake of convenience and is not meant to limit network adapter 14 from being internal to scanner 16. Computer 12 represents one of a plurality of computers that may be connected to network adapter 14 by way of communication link 18, which is otherwise known as a network 18. Network 18 may be a local area network, a wide area network or any other type of networking scheme.

Although computer 12 is representative of a multiple computers connected to network 18 only one is shown for the sake of clarity. Further, references to computer 12 as a selected computer 12 is then, for the sake of convenience, referring to a single computer 12.

Scanner 16 is representative of a scanning function, which can be a part of another device, such as an AIO 16. AIO 16 is a multifunction device that performs multiple tasks such as printing, copying, faxing and, of course, scanning.

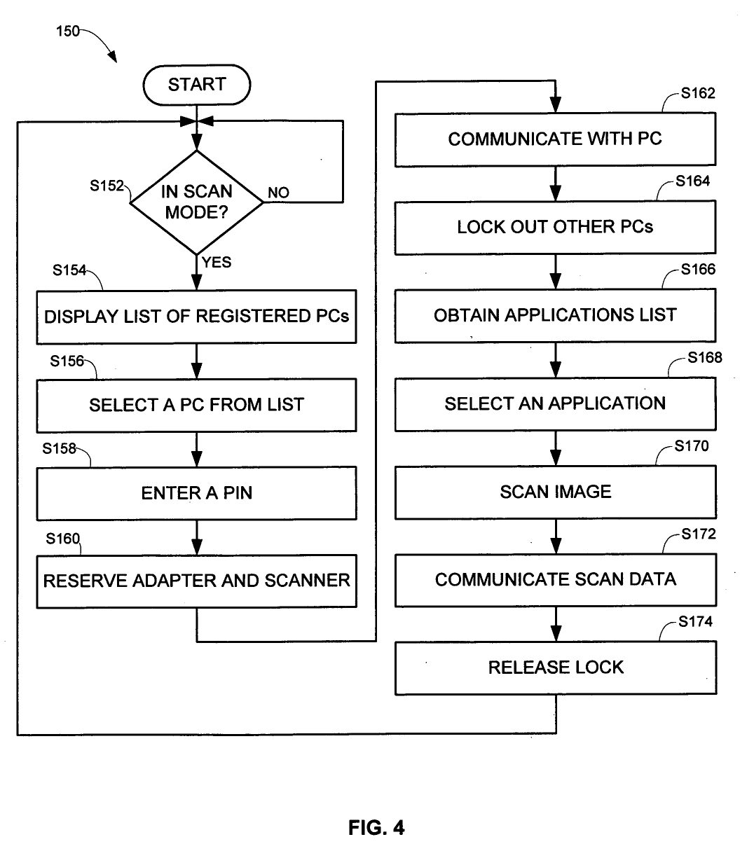

Now, additionally referring to FIG. 2, there is shown a method 50 of setting up a scanning system 10 (FIG. 1) so that it can subsequently execute method 150 (FIG. 4). At step S52, AIO 16 is network attached by way of communication link 20 to a network adapter 14. At step S54, AIO software is installed on each computer 12, also known as a PC, which will communicate with scanner 16 in executing method 150. At step S56, an application list is generated. Alternatively, an application list can be generated when the application list is requested in method 150 at step S166 (FIG. 4). The application list is a listing of software applications, which can utilize images scanned from scanner 16 and which will be made available to computer 12 by way of the AIO software installation. The application list can be updated upon the installation of further software applications on computer 12, which will utilize scanned images. The application list is maintained by the AIO software on computer 12 and is made available to scanner 16 upon request from scanner 16.

At step S58, the AIO software allows a computer 12 to be assigned a nickname. The nickname becomes part of a list of computer nicknames available at scanner 16 upon execution of method 150 to allow a user to select a desired computer 12 to serve as the destination host for image data generated by scanner 16. Additionally, the AIO software allows a security level in which a personal identification number (PIN) or security code is assigned and is associated with the computer nickname selected in step S58. Computer 12, by way of the AIO software installed thereon, maintains the applications list as well as the assigned nickname(s) of computer 12 and associated PIN numbers.

Now, further referring to FIG. 3, there is illustrated a method 100 in which computer 12 is registered in network adapter 14. At step S102, computer 12 communicates with network adapter 14 and registers with network adapter 14 to indicate that computer 12 has AIO software installed and is authorized and able to communicate with scanner 16. Registration of computer 12 includes storing the PC nickname assigned at step S58 and the PIN assigned at step S60. At step S104, the list of computers registered to function with AIO 16 is updated to reflect the list of registered computers 12 which are currently registered to interact with AIO 16. The updating process can add, revise and/or delete computers from the list of registered computers 12.

Now, additionally referring to FIG. 4, there is shown a method 150 of scanning an image from scanner 16 in the scanner system of FIG. 1. When system 10 is in a scan mode at step S152, method 150 proceeds to step S154. The determination as to whether system 10 is in a scan mode or not can include the detection of an insertion of documents into scanner 16, and/or a manual operator selection that indicates that a scan function is to be initiated. The indication by an input on an operator panel on scanner 16 can manually instruct method 150 that it is in a scan mode. Method 150 waits at step S152 if scanner 16 is not in a scan mode.

The list of registered computers, also known as registered PCs, which were registered at step S104 can be stored in memory 22 and/or memory 24. The information therein is communicated to scanner 16 and is displayed on an operational panel. The display can utilize the computer nickname assigned at step S58, thereby allowing a convenient selection of the destination computer. At step S156, an operator selects a particular computer 12 from the list that was displayed at step S154.

If the selected computer has an associated security code, the operator, at step S158, enters the security code or PIN. The entering of the security code or PIN provides a level of security so that unwanted images are not sent to computer 12. At step S160 network adapter 14 and scanner 16 reserve themselves from communicating with other computers until communicating with computer 12, thereby obviating a possible race situation if another computer were to attempt to communicate to adapter 14 and/or scanner 16. At step S162, scanner 16 communicates with the selected computer, which is herein referred to as computer 12 even though it is one of a multitude of computers connected to network 18. Selected computer 12 is in the list of registered computers since it has the AIO software installed therein and it has been registered in method 100 by way of the AIO software that was installed in method 50.

At step S164, scanner 16 communicates with computer 12 to notify the AIO software in computer 12 that computer 12 has been selected to receive image data. At step S164, network adapter 14 is captured by computer 12 and locks out other computers from accessing scanner 16. Following step S164, at step S166 scanner 16 is provided an application list which was generated at step S56. The application list is stored in memory 22 and/or 24. The application list is displayed on the operational panel of scanner 16, thereby allowing a user to view the available applications on computer 12. At step S168, the user selects at least one application from the application list displayed on the operational panel, thereby allowing scanner 16 to associate the selected application with the image data obtained by scanner 16 for delivery to computer 12.

At step S170 an image is scanned, upon automatic initiation or manually by way of the operational panel of scanner 16. The scanned image information is communicated to computer 12 at step S172. The scanned image information can be temporarily stored in memory 24 to buffer the data, it is then subsequently sent, by way of communication link 20, on to computer 12. Once the image information has been communicated to computer 12, the completion of the job is communicated to computer 12, allowing the AIO software on computer 12 to release the capture of network adapter 14, thereby releasing the lock instantiated at step S164. This makes scanner 16 again available for access by other computers by way of network 18. Releasing the lock at step S174 returns method 150 to step S152 where scanner 16 awaits an initiation into method 150 by again indicating that scanner 16 is in a scan mode.

While network adapter 14 has been explained as being the depository of the registered computer list, that information could also be contained in memory 24 of scanner 16. As previously mentioned, scanner 16 can be one part of AIO 16, which in addition to scanning images of documents can include printing, facsimile and copying functions as well.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of operating an image scanning system comprising an image scanner, a network adapter and a memory associated with at least one of the image scanner and the network adapter, said method comprising the steps of:
storing a list of one or more computers in the memory that are registered to interact with the image scanner via the network adapter; and
selecting one computer from said list of computers as a destination for scanned data.

2. The method of claim 1, further comprising the step of registering a computer to interact with the image scanner, thereby adding said computer to said list of computers.

3. The method of claim 2, wherein the network adapter is one of an external network adapter and an internal network adapter.

4. The method of claim 1, further comprising the step of receiving an applications list from said selected one computer.

5. The method of claim 4, further comprising the step of selecting at least one application from said applications list to be associated with the scanned data.

6. The method of claim 5, further comprising the step of reserving at least one of the network adapter and the scanner to communicate exclusively with said one selected computer.

7. The method of claim 6, further comprising the step of capturing the network adapter until a scan is completed and communicated to said one selected computer.

8. A method of operating an image scanner that is operatively connected to a network adapter and to a memory, the method comprising the steps of:
accessing a list of at least one registered computers stored in the memory, said list of registered computers being a list of computers that are registered to interact with the image scanner via the network adapter; and
selecting one computer from said list of registered computers as a destination for image data from the image scanner.

9. The method of claim 8, further comprising the step of registering a computer to interact with the image scanner, thereby adding said computer to said list of registered computers.

10. The method of claim 9, wherein the network adapter is one of an external network adapter and an internal network adapter.

11. The method of claim 8, further comprising the step of receiving an applications list from said one computer.

12. The method of claim 11, further comprising the step of selecting at least one application from said applications list.

13. The method of claim 12, further comprising the step of capturing the network adapter until a scan is completed and communicated to said one computer.

14. An image scanning system, comprising:
a computer;
a network adapter operatively connected to said computer; and
an image scanner operatively connected to said network adapter, at least one of said network adapter and said image scanner including a memory for receiving and storing a list of computers registered to interact with said image scanner.

15. The system of claim 14, wherein said image scanner includes a display panel upon which said list of computers is displayed, said computer being selected from said list thereby defining a selected computer.

16. The system of claim 15, wherein said network adapter provides said list of computers to said image scanner.

17. The system of claim 16, wherein at least one of said network adapter and said image scanner are reserved so as to communicate exclusively with said selected computer.

18. The system of claim 17, wherein said selected computer captures said network adapter.

19. The system of claim 18, wherein said network adapter locks out all computers except said selected computer from interacting with said image scanner.

20. The system of claim 19, wherein said image scanner receives a list of applications from said selected computer.

21. The system of claim 20, wherein said image scanner displays said list of applications from which at least one application is selected.

22. The system of claim 20, wherein said image scanner scans an object thereby creating scan data, said scan data being communicated to said selected computer.

23. The system of claim 22, wherein said network adapter releases said selected computer from being captured upon completion of said scan data being communicated to said selected computer.
